(19) United States
(12) Patent Application Publication
(10) Pub. No.: US 2012/0073739 A1
(43) Pub. Date: Mar. 29, 2012

(54) ADVANCED UNIDIRECTIONAL MATERIAL COMPRESSION-MOLDED FACE COMPONENT

(75) Inventors: J. ANDREW GALLOWAY, ESCONDIDO, CA (US); YVONNE GALLOWAY, ESCONDIDO, CA (US)

(73) Assignee: CALLAWAY GOLF COMPANYH, CARLSBAD, CA (US)

(21) Appl. No.: 13/214,494

(22) Filed: Aug. 22, 2011

Related U.S. Application Data
(60) Provisional application No. 61/376,187, filed on Aug. 23, 2010.

(51) Int. Cl. B29C 43/20

(52) U.S. Cl. 156/245

(57) ABSTRACT

A method for manufacturing a face component of a golf club head from slit plies of unidirectional pre-preg material is disclosed herein. The slitting is preferably diagonally along the unidirectional pre-preg material. The slit plies are placed in a mold in an alternating manner and the plies are compressed to form the face component. The slitting allows the pre-preg material to move within the mold during the compressing step.

### CROSS REFERENCES TO RELATED APPLICATIONS

The Present Application claims priority to U.S. patent application No. 61/376,187, filed on Aug. 23, 2010, which is hereby incorporated by reference in its entirety.

### STATEMENT REGARDING FEDERALLY SPONSORED RESEARCH OR DEVELOPMENT

Not Applicable

### BACKGROUND OF THE INVENTION

1. Field of the Invention

The present invention relates to manufacturing components for golf club heads. More specifically, the present invention relates to a method for manufacturing a face component for a golf club head.

2. Description of the Related Art

The prior art discloses multiple material golf club heads.

There are various problems with the current process for manufacturing multiple material golf club heads.

One problem is with the standard compression molding process, the hard metal tooling on both sides of the part makes undercuts impossible without significant increases in tool complexity.

Another problem is the molding compounds are not designed to be used in parts with very thin walls. When wall thicknesses are below approximately 0.080 inch, most standard molding compounds are difficult to compression mold.

Another problem is that standard molding compounds are not as strong, stiff, or tough as laminated composites made with similar matrix and fiber types.

Another problem is the raw materials for the current laminates are quite expensive. The cost is compounded by the very high scrap rate.

Another problem is that using prepreg requires hand placement of each layer of material into a mold which is a time-consuming and labor-intensive process.

Another problem is that with current latex bladders we are able to avoid undercut constraints, but we lose definition on the inside of our parts. The metal tooling dictates OML of the parts quite well, but the part thickness and IML are determined by the number of plies placed in each area and the amount of pressure exerted on the area by the bladder during the cure. As a result, it is difficult to predict the mass properties of the Fusion body before a part is made. One-piece bladder molded driver bodies do not work well with a body-over-face joint. The lack of precision on the inside of the head makes it difficult to control the geometry of the body where it would meet up with the face. Bladder molded multiple material driver design had been restricted to body-under-face joints so that the body bond surface is a well controlled OML surface. Typical epoxy-based prepregs are designed to cure in 20-30 minutes. In the current multiple material golf club head fabrication process, the latex bladders used to apply pressure during the cure cycle can only be used 2 or 3 times before they need to be discarded. Bladders are a significant cost in the current multiple material driver manufacturing process.

Manufacturing a titanium face component for a golf club head is expensive. Use of current carbon fiber techniques to manufacture face components is also expensive.

### BRIEF SUMMARY OF THE INVENTION

A carbon face component is produced b simplifying the construction and forming process. Unidirectional carbon epoxy material can be sourced with diagonal slits, across the pre-impregnated carbon fibers. The slitting allows the material to move during the compression molding process. The ability to move and fill the tool simplifies the manufacturing process. In this invention, layers of the slit unidirectional material are placed in the mold in alternating orientations. The layers of the material do not need to be conformal to the tool nor cover the surface of the tool as the material will move and fill the cavity as the compression mold closes. The material cures quickly by formulation and superior heat transfer in the compression mold. The near net face component emerging from the tool can now be joined to a body. The body can be on many constructions, but preferably is constructed of titanium sheets or carbon composite. The selection of the body construction determines the cost, playing performance and sound of the finished club head.

Having briefly described the present invention, the above and further objects, features and advantages thereof will be recognized by those skilled in the pertinent art from the following detailed description of the invention.

### DETAILED DESCRIPTION OF THE INVENTION

A method for forming a face component is disclosed herein.

The final golf club head is preferably as disclosed in U.S. Pat. No. 6,582,323 for a Multiple Material Golf Club Head, which is hereby incorporated by reference in its entirety.

Alternatively, the final golf club head is preferably as disclosed in U.S. Pat. No. 7,320,646 for a Multiple Material Golf Club Head, which is hereby incorporated by reference in its entirety.

Alternatively, the final golf club head is preferably as disclosed in U.S. Pat. No. 7,431,666 for a Golf Club Head With A High Moment Of Inertia, which is hereby incorporated by reference in its entirety.

Alternatively, the final golf club head is preferably as disclosed in U.S. Pat. No. 7,390,269 for a Golf Club Head, which is hereby incorporated by reference in its entirety.

Variable face thickness patterns of the striking plate insert are disclosed in U.S. Pat. No. 6,471,603, for a Contoured Golf Club Face, U.S. Pat. No. 6,368,234 for a Golf Club Striking Plate Having Elliptical Regions Of Thickness, U.S. Pat. No. 6,398,666 for a Golf Club Striking Plate With Variable Thickness, U.S. Pat. No. 7,448,960, for a Golf Club Head With Face Thickness which are all owned by Callaway Golf Company and which pertinent parts related to the face pattern are hereby incorporated by reference.

The mass of the club head of the present invention ranges from 165 grams to 250 grams, preferably ranges from 175 grams to 230 grams, and most preferably from 190 grams to 205 grams. Preferably, the subassembly preferably has a mass ranging from 140 grams to 200 grams, more preferably ranging from 150 grams to 180 grams, yet more preferably from 155 grams to 166 grams, and most preferably 161 grams. The crown component has a mass preferably ranging from 4 grams to 20 grams, more preferably from 5 grams to 15 grams, and most preferably 7 grams.

The golf club head preferably has that ranges from 290 cubic centimeters to 600 cubic centimeters, and more preferably ranges from 330 cubic centimeters to 510 cubic centimeters, even more preferably 350 cubic centimeters to 495 cubic centimeters, and most preferably 415 cubic centimeters or 470 cubic centimeters.

The center of gravity and the moment of inertia of a golf club head are preferably measured using a test frame (X^{T}, Y^{T}, Z^{T}), and then transformed to a head frame (X^{H}, Y^{H}, Z^{H}). The center of gravity of a golf club head may be obtained using a center of gravity table having two weight scales thereon, as disclosed in U.S. Pat. No. 6,607,452, entitled High Moment Of Inertia Composite Golf Club, and hereby incorporated by reference in its entirety.

The moment of inertia, Izz, about the Z axis for the golf club head preferably ranges from 2800 g-cm² to 5000 g-cm², preferably from 3000g-cm² to 4500 g-cm², and most preferably from 3750 g-cm² to 4250 g-cm². The moment of inertia, Iyy, about the Y axis for the golf club head preferably ranges from 1500 g-cm² to 4000 g-cm², preferably from 2000 g-cm² to 3500 g-cm², and most preferably from 2400 g-cm2 to 2900 g-cm². The moment of inertia, Ixx, about the X axis for the golf club head 40 preferably ranges from 1500 g-cm² to 4000 g-cm², preferably from 2000 g-cm² to 3500 g-cm², and most preferably from 2500 g-cm² to 3000 g-cm².

The golf club head preferably has a coefficient of restitution a (“COR”) ranging from 0.81 to 0.875, and more preferably from 0.82 to 0.84. The golf club head preferably has a characteristic time (“CT”) as measured under USGA conditions of 256 microseconds.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. A method for forming a face component of the golf club head, the method comprising:
slitting a plurality of plies of pre-preg unidirectional material to create a plurality of slit plies of pre-preg unidirectional material;
placing the plurality of slit plies of pre-preg unidirectional material in a mold for a face component of a golf club head in an alternating manner;
closing the mold; and
compressing the plurality of slit plies of pre-preg unidirectional material into a shape of a face component for a golf club head.

2. The method according to claim 1 wherein the face component comprises a striking plate portion and a return portion.

3. The method according to claim 1 wherein the number of plies of plurality of plies of pre-preg unidirectional material ranges from 2 to 20.

4. The method according to claim 1 wherein the number of plies of plurality of plies of pre-preg unidirectional material ranges from 3 to 10.

5. The method according to claim 1 wherein the depth of the slit of each of the plurality of slit plies of pre-preg unidirectional material ranges from 0.5 mm to 5 mm.

6. The method according to claim 1 wherein the slits in each of the plurality of slit plies of pre-preg unidirectional material ranges from 1 per centimeters squared to 10 per centimeters squared.

7. The method according to claim 1 wherein the face component has a thickness ranging from 1 mm to 5 mm.

8. The method according to claim 2 wherein the striking plate portion of the face component has variable thickness.
